(19) United States
(12) Patent Application Publication
(10) Pub. No.: US 2004/0117294 A1
(43) Pub. Date: Jun. 17, 2004

(54) System and methods for facilitating commerce in component-based industries

(75) Inventors: Michael A. Ferraro, Wellington, FL (US); Frank Ferraro, Wellington, FL (US)

Correspondence Address: GREENBERG-TRAURIG, 1750 TYSONS BOULEVARD, 12TH FLOOR, MCLEAN, VA, 22102, US

(73) Assignee: PlantFind.com, Inc., Boynton Beach, FL (US)

(21) Appl. No.: 10/616,233

(22) Filed: Jul. 10, 2003

Related U.S. Application Data
(60) Provisional application No. 60/394,956, filed on Jul. 10, 2002.

(51) Int. Cl. G06F 17/60

(52) U.S. Cl. 705/37

(57) ABSTRACT

A system and methods for managing and transacting business in a component-based industry, and especially the Green Industry. The invention includes a database of materials offered by suppliers in the industry, preferably including inventory, pricing, quality, and other specifications related to the materials. The invention allows buyers to enter material information, including specifications, to create a request for quotation (RFQ's), and the invention can analyze the RFQ's and distribute them to appropriate suppliers, thereby streamlining the RFQ process. The invention also preferably includes business management software, which helps automate business operations for the suppliers, and keeps the information in the database current. In addition to RFQ's, the invention also allows buyers to purchase material from suppliers through a virtual storefront interface. The invention also facilitates the creation of virtual trade shows, and auctions of various materials, and can disseminate news and other information.

This application is related to and claims priority from Provisional U.S. patent application Ser. No. 60/394,956, filed Jun. 10, 2002, which is hereby incorporated by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of computer software design, and more specifically provides a system and method for locating suppliers of required materials in an efficient manner, including obtaining pricing, inventory levels, and other required information about the materials, and for facilitating commercial transactions between buyers and sellers.

### BACKGROUND OF THE INVENTION

The estimated $167 billion Green Industry encompasses the production, distribution and marketing of ornamental horticulture plants, such as trees and shrubbery, potted plants, and floricultural plants and flowers. The Green Industry also includes the purchase and sale of associated supplies, materials and equipment, including heavy and light machinery, hand tools, power tools, irrigation supplies, clothing, structures, and the like (collectively referred to as “materials” herein).

Materials are presently bought and sold through a network of growers, grower-wholesalers, re-wholesalers, brokers, manufacturers and distributors, and are delivered from various regions in the U.S. to brokers, re-wholesalers, contractors, retail nurseries, garden centers, amusement parks, golf courses, mass merchants, supermarkets, government entities, and other customers. At each level of the distribution chain, material pricing will vary depending upon several factors, such as plant size, container size, location, and plant availability, grade and quality. Perishable items, such as those at the core of the green industry, need to be sold or delivered in a timely manner to buyers for reasons of freshness, size, harvesting and planting seasons, and project completion dates.

Currently, buyers in the Green Industry locate materials by searching printed sourcing guides. Sourcing guides are essentially catalogs of materials available from a large number of suppliers, with the suppliers generally located within the same geographic area as the buyer. Due to a variety of factors, including the compilation, publishing, and distribution times associated with creating and distributing sourcing guides, and the dynamic nature of the materials and inventories listed in such guides, information in a sourcing guide is typically outdated even before the sourcing guide is received by a buyer. Sourcing guides therefore tend to serve as a means of locating a supplier that generally carries the materials being sought; they inherently cannot convey accurate inventory, quality, size, or similar such information. Other sourcing guide problems include the fact that traditionally, sourcing guides have been printed for different geographical regions, and the fact that separate sourcing guides are typically created for non-plant materials such as tools, heavy equipment, chemicals, clothing, structures, and non-living natural products such as mulch or decorative stone.

Because of the inherent problems with sourcing guides, buyers typically use the sourcing guides simply as a means to identify one or more suppliers who tend to carry products which the buyer wishes to purchase. When the buyer has identified such a supplier, the buyer must contact them by phone or fax and request material availability and pricing information from the supplier. This is typically done by the buyer generating a “request for quote”, or RFQ. Generally, each RFQ contains all of the items for which the buyer is searching, even though the supplier receiving the quote may not carry all of the items or may only have a limited number of the requested items in stock. Each supplier typically manually completes the quote for the items in inventory and calls or faxes the information back to the buyer. The buyer must then manage all of the received quotes and decide where the best price can be found relative to available inventory supplies and material specifications (such as sizes). This results in significant inefficiencies in ordering and fulfillment. For example, the typical timeline for simply confirming the location of supplies is between 3 to 5 working days; when order processing, shipping, and related times are taken into account, even orders for in-stock materials may take several weeks to fill not taking into account the shipping process.

Green Industry suppliers have their own difficulties utilizing printed sourcing guides to their fullest potential. Two of the biggest problems faced by Green Industry suppliers are sourcing guide publication costs and publication frequency. Because many of the items listed in a sourcing guide are perishable, inventories and prices change on an almost daily basis, yet most sourcing guides are printed on a monthly basis, with some even printed on a semi-annual or annual basis. Thus, it is difficult for suppliers to provide accurate inventory and pricing information to buyers through sourcing guides.

Another problem Green Industry suppliers face is physical space constraints within sourcing guides. Suppliers must pay a fee for each item listed in a printed sourcing guide, and it is therefore typically financially prohibitive for larger suppliers to list all of the items they carry or to which they have access. This inevitably leads to lost business for larger suppliers on items they could have sold if they had listed their complete inventory in the guide.

As described above, the Green Industry market is made up of a large number of buyers and sellers at various stages of the supply chain. For example, there are sectors for Growers, Wholesalers/Re-Wholesalers/Brokers/Distributors, Landscape Contractors/Grounds Maintenance Services, and Retailers.

The flow of green materials generally starts with a breeder/propagator, part of the Grower sector. A breeder/propagator generally provides cuttings, seeds, or bulbs to a second grower. The second grower will grow plugs, seedlings, transplants, tissue-culture plantlets, nursery lining-out stock, or the like from the materials provided by the first grower, and these are sold to third growers. A third grower may “grow-on” the second grower's young plant stock to market size (pre-finished) or to an intermediary-sized product.

At this stage, the third grower may sell material of different sizes, quality, and specifications to a wide-array of corporate buyers. These buyers typically include wholesalers, re-wholesalers, brokers, and distributors, who then sell the material to consumers, although third growers may also sell directly to consumers. Examples of consumers to whom third growers sell directly include landscape contractors, lawn and garden care companies, grounds maintenance firms, retail nurseries, mass merchants, home and garden centers, florists, government agencies, hotel chains, theme parks, golf courses, recreational fields, corporate accounts, and even individuals.

Even before Green Industry materials begin wending their way through the stream of commerce, they may pass between two, three, or even more of the 68,000 growers in the United States. Likewise, the materials can be exchanged several times by the 27,000 businesses in the wholesale trade sector before they move to the 84,000 businesses in the services sector or the 140,000 businesses in the retail trade sector. Clearly, the dynamic nature of the Green Industry makes it difficult for businesses to locate materials they actually need.

By way of a more illustrative example of the complex stream of commerce in the Green Industry, a nursery may not grow all of its plants from seeds. Instead, they may periodically purchase seedlings/liners from another nursery that specializes in early plant growth. Once the plants are mature, the nursery may sell the mature plants to wholesale and established retail and garden centers like Wal-Mart, Lowe's, or Home Depot. Nurseries may also sell plants directly to the public through the nursery's own retail store, or use the plants as part of an landscaping project managed by the nursery's landscaping division. Because of varying maturation rates, individual material size and quality, localized issues such as weather or insect infestation, unexpected bulk purchases, and other such factors, it is generally difficult for the various entities to find one supplier that carries all of the items needed on a day to day basis to run their business and serve their customers.

### SUMMARY OF THE INVENTION

Accordingly, the present invention is directed to a system and methods for facilitating commerce in component-based industries, and more specifically to the Green Industry, that substantially obviates one or more of the problems due to limitations and disadvantages of the related art.

An object of the present invention is to provide buyers with easy access to accurate inventory levels from a plurality of sellers.

Another object of the present invention is to provide sellers with a convenient means through which material information, including, but not limited to, pricing and inventory information, can be provided to buyers.

Still another object of the present invention is to facilitate material purchases by buyers.

Yet another object of the present invention is to provide a means through which RFQ's can be automatically generated, and which can readily and automatically identify suppliers capable of filling part or all of an RFQ.

It is another object of the present invention is to allow buyers to perform the equivalent of searching multiple sourcing guides in a single operation.

It is still another object of the present invention to allow sellers to receive “public” RFQ's from buyers, thereby allowing sellers to offer materials to new buyers.

A further object of the invention is to allow buyers to purchase multiple products from multiple sellers, or catalogs, and to “check out” as though the transaction were a single transaction.

Still a further object of the invention is to allow sellers and other interested parties to create virtual trade shows.

Another object of the invention is to tie business management and E-commerce functions together with an electronic marketplace, thereby increasing informational and business efficiencies for both buyers and sellers.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention includes a system, methods, and computer program processes which facilitate commerce between buyers and sellers. A preferred embodiment of the invention is designed for the Green Industry, but it should be apparent to one skilled in the art that the system and methods described herein can be adapted for use in alternative industries as well. By way of example, without intending to limit the present invention, alternative embodiments of the present invention include those directed to the restaurant, medical equipment, automotive parts, construction supplies, and similar industries.

A preferred embodiment of the present invention allows members of the Green Industry to locate suppliers of required or desired materials in an efficient manner, and to obtain pricing and other required information on the materials. The invention also preferably provides means through which buyers can purchase materials directly from one or more suppliers identified by the invention with a minimum of direct contact between the buyer and seller, monitor industry news, research materials and sellers, and even manage accounting, inventory, and related back-end information.

The invention is preferably comprised of several related software components that manage different aspects of the inventory, research, and buying process, but overall contribute to making the entire process more efficient and accurate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of software components and tools provided in a preferred embodiment of the present invention.

FIG. 2 is a block diagram illustrating a network architecture capable of supporting the present invention.

FIG. 3 is a screen capture of a sample user interface which provides access to the tools and components of the present invention.

FIG. 4 is a screen capture of a sample user interface which allows a user to search material records.

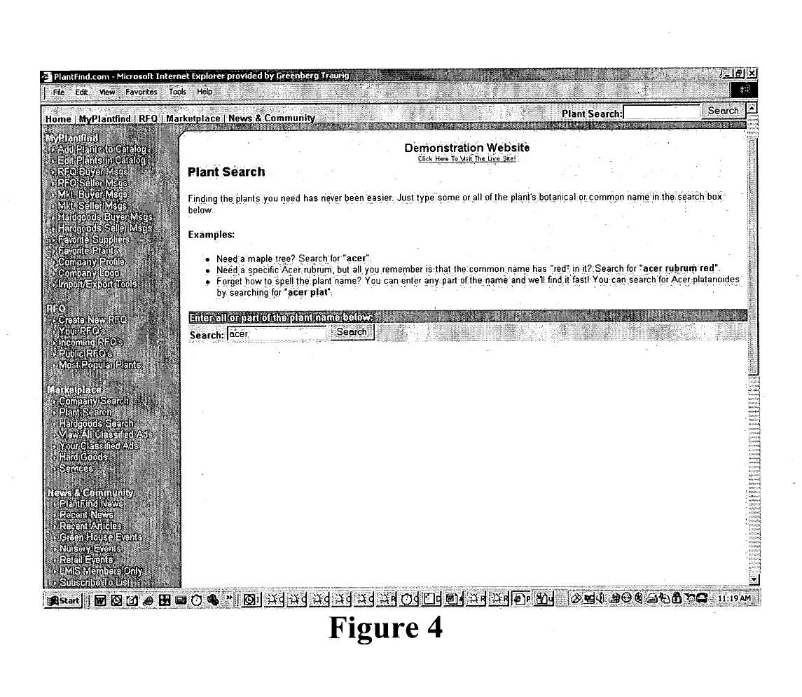

FIG. 5 is a screen capture of a sample user interface providing a report of materials matching a user search request.

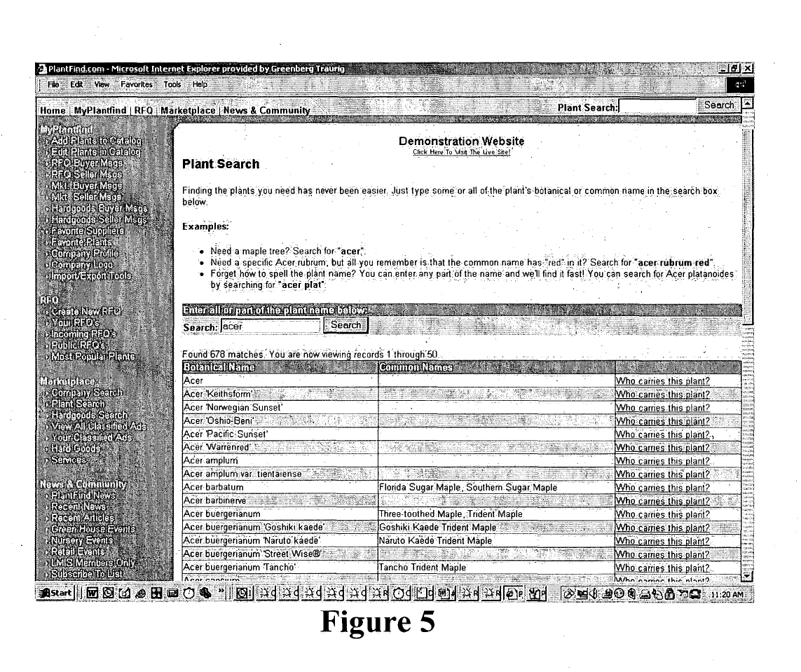

FIG. 6 is a screen capture of a sample user interface providing access to company and material information.

FIG. 7 is a screen capture of a sample user interface which allows a user to search for suppliers by name and/or geographic location.

FIG. 8 is a screen capture of a sample user interface providing a report of suppliers matching a user search request.

FIG. 9 is a screen capture of a sample user interface providing access to news, events, articles, and the like.

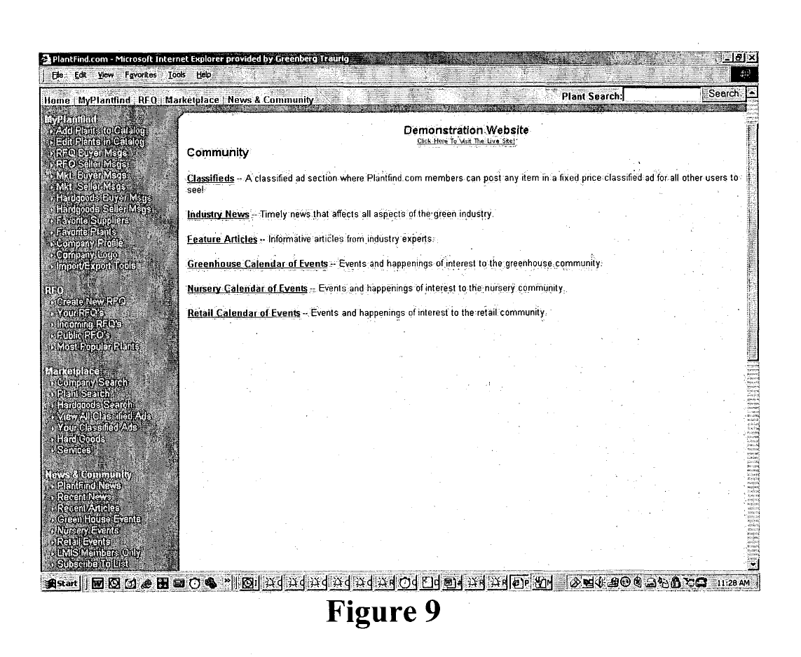

FIG. 10 is a screen capture of a sample user interface through which a request for quote can be entered into the present invention.

FIG. 11 is a screen capture of a sample user interface for a request for quote report screen.

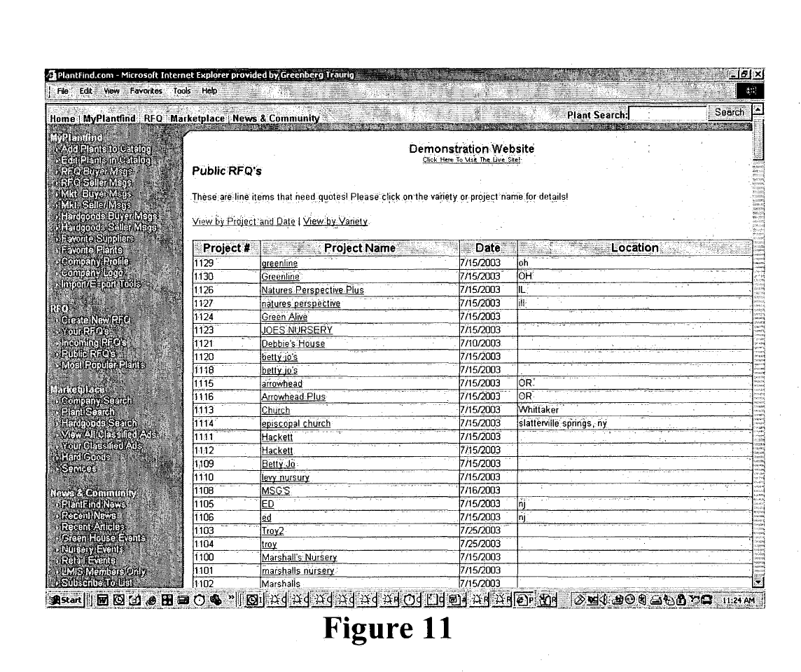

### DETAILED DESCRIPTION OF THE PREFERRED EMBODIMENT

Reference will now be made in detail to the preferred embodiments of the present invention, examples of which are illustrated in the accompanying drawings. As used herein, the terms seller and supplier are intended to be effectively synonymous.

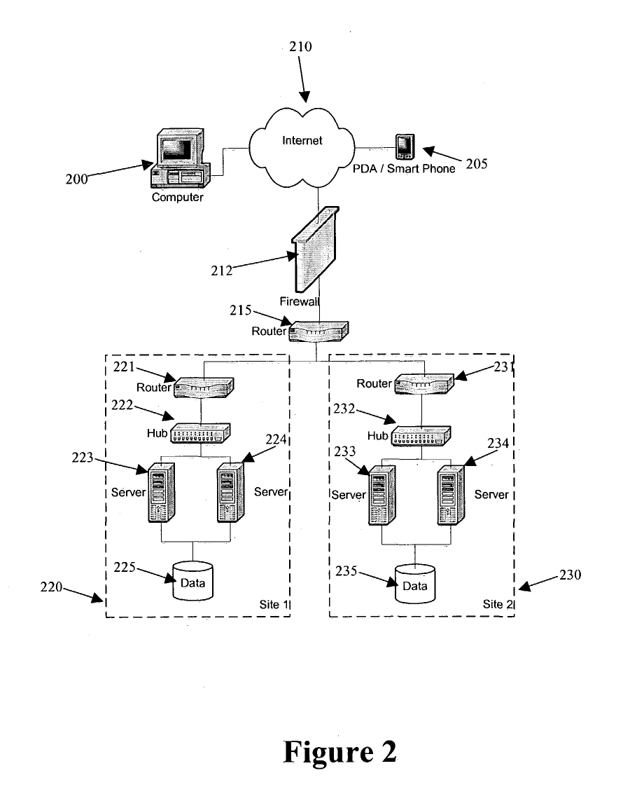

FIG. 2 is a block diagram illustrating a network architecture capable of supporting the present invention. A preferred embodiment of the present invention provides software components and tools to users as a hosted software platform, meaning copies of the software are not distributed directly to users. Instead, the software is preferably installed and maintained within a centralized network environment similar to that of FIG. 2. Such a network environment preferably includes a plurality of servers 223, 224, 233, and 234, which are preferably distributed across physical facilities 220 and 230 to provide redundancy, improved stability, reduced latency times, and the like. In the network architecture illustrated in FIG. 2, routers 215, 221 and 231 provide connectivity between Site 1 (220), Site 2 (230), and Internet 210.

The connection between Internet 210 and router 215 is preferably secured using firewall 212 or other security means. In the distributed network architecture illustrated in FIG. 2, router 215 preferably includes a load balancer or other network redirection means, which allows requests coming into the network from Internet 210 to be distributed between Site 1 (220) and Site 2 (230). Within each of Site 1 (220) and Site 2 (230), routers 221 and 231 preferably include load balancers or other network redirection means, which allow requests coming into each of the sites to be distributed among the servers within the site. Databases 225 and 235 are preferably implemented as a redundant array of inexpensive disks (RAID array) using RAID level 5 (striping with parity) to reduce data retrieval times and improve data availability. In a preferred embodiment, databases 225 and 235 are routinely synchronized. Although a distributed network environment similar to FIG. 2 is preferred, it should be apparent to one skilled in the art that alternative network embodiments, including implementing the features of the present invention using a single server, can be employed without departing from the spirit or the scope of the invention.

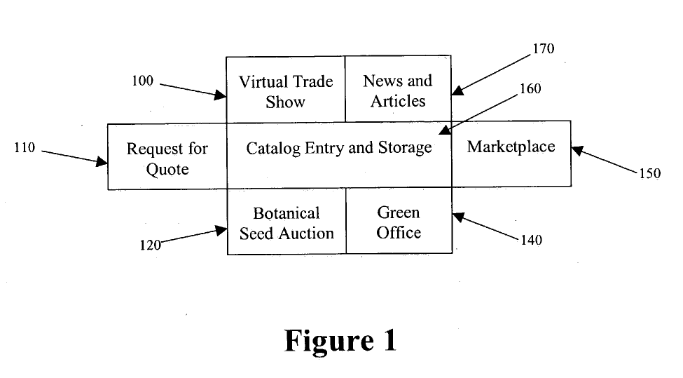

FIG. 1 is a block diagram of software components and tools provided in a preferred embodiment of the present invention. In a preferred embodiment, users purchase a license to use some or all of the software components and tools for a specific period of time, usually 1 year. The software components and tools that make up a preferred embodiment of the present invention include a catalog entry and storage component 160, a marketplace component 150, a request for quote tool 110, a botanical seed auction tool 120, a virtual trade show component 100, a collection of back-end tools (referred to herein as Green Office 140), and a news reporting tool 170. Descriptions of these software components and tools are included below.

Catalog Entry and Storage 160

Catalog storage and editing system is the core of the present invention. Catalog storage and editing system 160 preferably allows material suppliers to list all of their materials in one consolidated location. Catalog storage and editing system 160 is preferably implemented as one or more database tables within databases 225 and 235 of FIG. 2. Once listed in the catalog, materials and other information entered into catalog storage and editing system 160 may be accessed and used by the other software components and tools of the present invention, including as described below. Because catalog storage and editing system 160 is preferably implemented using an Internet-based computer system, suppliers may modify their catalog entries 24 hours a day, 7 days a week. A preferred embodiment of the present invention does not impose limits on the number of items that may be listed, other than the inherent system capacity limitation.

The primary interface for editing the catalog is preferably an Internet accessible web site. Additional interfaces may be created by an operator of the present invention for performing bulk material information insertions and various other catalog maintenance activities. These additional interfaces may also be made available to sellers to allow them to perform such maintenance activities themselves.

Databases 225 and 235 of FIG. 2 are preferably relational database systems which allow for fast retrieval of necessary information to whatever “front-end” application is requesting the data. The architecture of the present invention supports one or more front-end applications running on one or more of servers 223, 224, 233, or 234, regardless of whether such an application is implemented as a web-based interface, compiled desktop application, or other application form.

Additional supporting information is preferably stored in databases 225 and 235, including, but not limited to, a master list of plants commonly used within the Green Industry, geographical information, reference information on the plants (statistics, growing zones, reference images, and the like). Supporting information may be used by the front-end applications as needed.

Green Office 140

To facilitate maintenance of accurate and up to date information in catalog entry and storage 160, the present invention preferably also includes green office 140. Green office 140 is a set of business tools tailored to the Green Industry. By way of example, without intending to limit the present invention, green office 140 can include software which performs functions associated with accounting, general ledger/accounts receivable, and accounts payable; inventory tracking and management; job estimating and creating customer proposals; job costing and job management; payroll; and the like. As with the remainder of the present invention, these functions are preferably provided via a hosted software platform.

The business management, or back-end, software currently available to the Green Industry has only limited capabilities because the applications are generally geared toward more traditional industries. In those rare instances where custom applications have been developed, the applications are very customer-specific, and are not readily adaptable to other customers. General industry applications do not meet the needs of the unusual Green Industry business models, and custom applications are expensive to develop and to maintain. This results in many dissatisfied buyers and sellers. The present invention provides an enterprise software application that meets the needs of the Green Industry. However, the software has been architected to facilitate transitions to other industries as well. Although the business management software implemented in a preferred embodiment of the invention is semi-custom software, development and maintenance costs are distributed across many customers, thereby making the software much more cost effective. A preferred embodiment of the invention also allows customers to access their information through a secure, web-based interface so that they can price, track and maintain accounts for every job or purchase, even remotely.

As described below, Green Office 140 preferably integrates with catalog storage and editing system 160 and allow buyers to easily order materials based on current available inventory. Green Office 140 can receive information from, and provide information to, system will be available for use by computer, cell phone, or any wireless application (PDA), to give the businesses the flexibility to utilize the system 24/7 and from a remote location.

Request for Quote (RFQ) 110

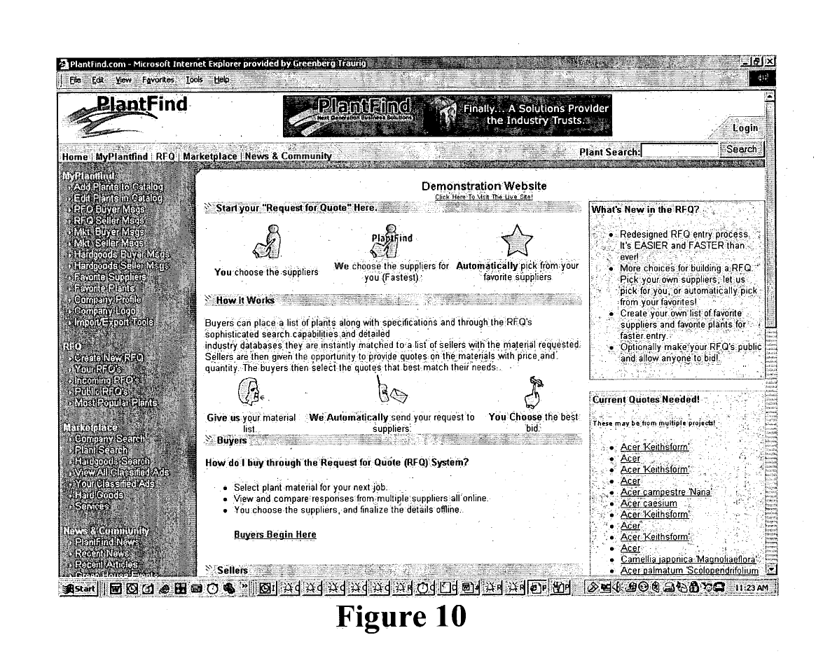

As illustrated in FIG. 1, request for quote tool 110 provides buyers with a means of selecting materials from catalog entry and storage 160 and compiling a single, comprehensive request for quote. FIG. 10 is a screen capture of a sample user interface through which a request for quote can be initiated with the present invention. Request-specific information, such as, but not limited to, quantity, size, variety, color, power, and capacity, may also be provided by the buyer as part of the request for quote process.

Referring again to catalog entry and storage 160, catalog entry and storage 160 preferably permits materials to be classified in a hierarchical manner, thereby facilitating the creation of RFQ's. By way of example, without intending to limit the present invention, there are several different companies that make shovels, and a variety of shovel shapes and sizes are available. Some buyers' needs dictate the use of a very specific shovel type, and thus catalog entry and storage 160 allows a seller to list the manufacturer, handle length, blade size, minimum handle breaking force, or other distinguishing features, thereby facilitating selection of such narrow needs. However, for other buyers, such specificity is neither needed nor warranted. To that end, catalog entry and storage 160 also preferably allows a seller to list the shovel under one or more generic categories, such as “shovel”, as well as one or more sub-categories based on common use, blade shape, or other appropriate information. This classification method permits buyers whose requirements are not as stringent to more easily receive and review information regarding a wider range of materials that will meet their needs.

Once a request for quote is received from a buyer, the contents of the RFQ is compared against information from catalog entry and storage 160 to locate suppliers that carry materials matching the requirements specified in the RFQ. While this process is similar to how a buyer would manually lookup such information in a printed sourcing guide, the process takes mere seconds to identify all suppliers on the system with the product in their catalog, compared to hours of manual searching for a limited number of suppliers that may list the product due to line-item costs charged by most printed publications. One reason a preferred embodiment of the present invention is able to compare the RFQ and information in catalog entry and storage 160 to provide accurate information is because of the tight integration of catalog entry and storage 160 with green office 140, and especially the inventory aspects thereof. Once the suppliers are selected, each supplier will preferably receive a modified copy of the RFQ, showing only RFQ entries corresponding to material carried by the supplier.

This process benefits the buyer in several ways. The buyer is exposed to more potential suppliers than they might otherwise encounter in a printed sourcing guide because suppliers can list a wider selection of materials in their online catalogs (the present invention preferably does not charge a line-item cost), thereby increasing the potential number of suppliers of a given good. The present invention also allows buyers to access inventory and other information from suppliers both within and outside the buyer's geographic area. By submitting the RFQ to more suppliers, the buyer increases competition on many of the items, increases the likelihood of finding material that can be delivered within a given deadline, and benefits from other advantages as well. Furthermore, through the system and methods of the present invention, a buyer can receive quotes in minutes, rather than days.

The present invention benefits not only buyers, but also sellers. The present invention benefits sellers by exposing them to buyers on the basis of the material in their inventory, rather than how large they are, how well known they are, or where they are physically located. By receiving more RFQ's, the suppliers increase their chances of closing more deals and selling more material.

Furthermore, suppliers preferably only see requests for the line items they carry, and even preferably only those items in inventory. This speeds the process of responding to a quote by eliminating the need to check for materials they do not have in stock, and eliminates the time involved in reviewing large RFQ's comprised almost exclusively of materials not carried by the supplier. The supplier is also freed from receiving RFQ's only by phone or fax. The system allows the supplier to choose one or more preferred contact methods, including fax, email, online notification, PDA, or cell phone. When a supplier provides a quote, they need only provide a price, although the present invention preferably allows suppliers to add additional comments or information about the materials if desired. Once information is received from the supplier, the RFQ is automatically routed back to the buyer without the worry of misdialed or incorrect fax numbers, lost faxes, illegible handwriting, or the like.

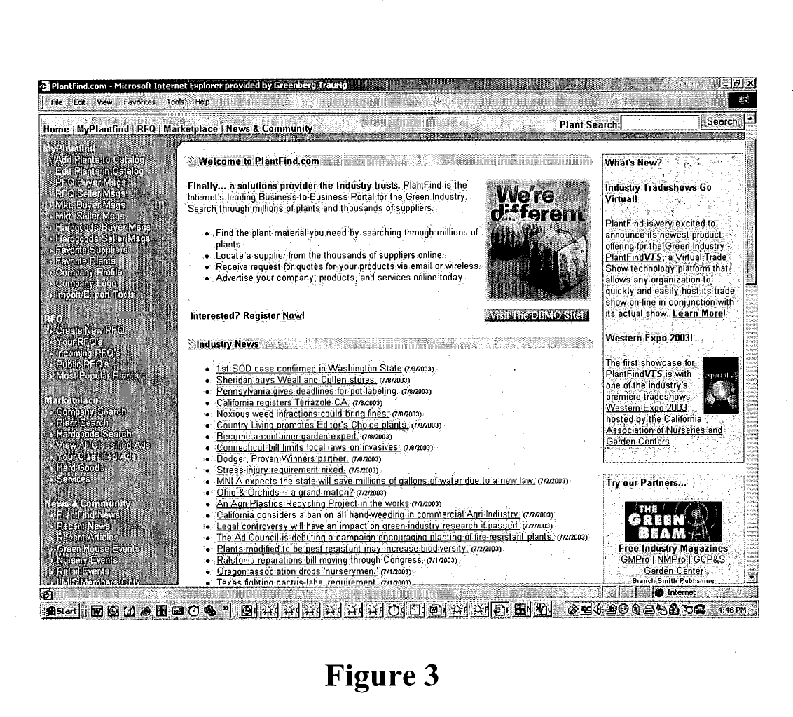

Through the present invention, sellers can also track buyer requests to monitor buyer demand for given materials. By way of example, without intending to limit the present invention, the present invention can periodically generate and E-mail a “top-100” list, containing the one hundred most frequently requested materials to suppliers. Alternatively, the present invention may dynamically generate such a list each time a seller engages the invention. FIG. 3 is a screen capture of a sample user interface which provides access to the tools and components of the present invention, and can be used to present such reports to all visitors, or subsets thereof based on their role as buyers or sellers, the types of materials typically bought/sold by the visitor, and the like. RFQ responses can also be mined for additional information, including, but not limited to, industry average pricing for specific materials, regional pricing, material availability, and the like.

Once the buyer receives information regarding a RFQ from one or more suppliers, information from the RFQ is preferably compiled into meaningful reports showing the buyer important statistics such as the lowest price quoted for each line item, the highest price quoted for each line item, the average price quoted for each line item, the number of requested items available at a single supplier, and the like, thereby simplifying the buying process later.

RFQ's can be stored indefinitely, allowing both the buyer and seller to refer to them at a later date for such purposes as allowing buyers to estimate similar requests without submitting a new RFQ, allowing sellers to prospect and directly advertise to buyers that were searching for materials they carried at one time or another, and allowing suppliers to gauge the relative demand for various materials over time.

Marketplace 150

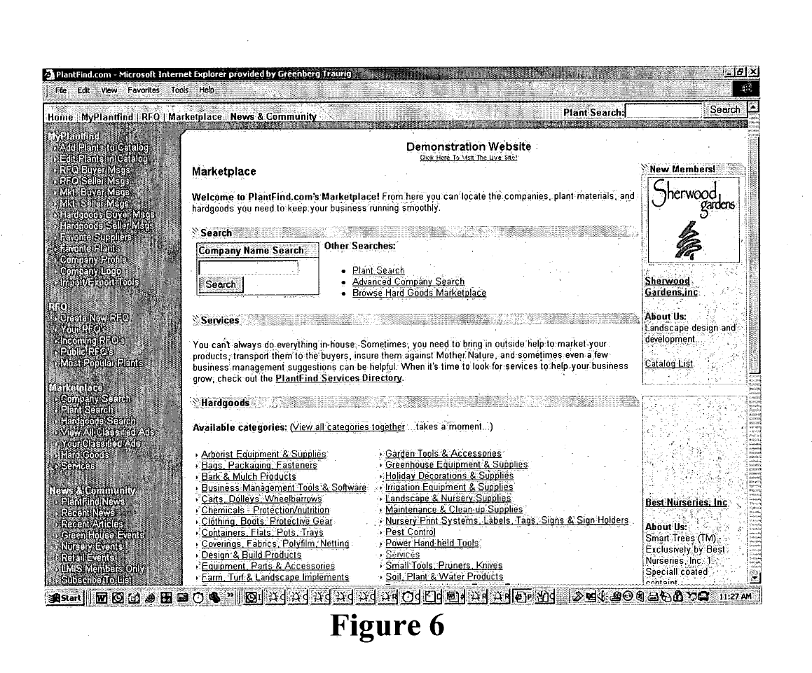

FIG. 6 is a screen capture of a sample user interface providing access to company and material information. Marketplace 150 integrates with catalog entry and storage 160 and allows sellers to publicly display a catalog of materials in a manner similar to a traditional electronic storefront. A preferred embodiment of the present invention allows sellers to privately label their catalog, such that a buyer is unaware that the catalog is being presented through the present invention. Marketplace 150 preferably allows buyers to browse seller materials sorted by various relevant categories, and preferably allows buyers to search for, inquire about, and purchase items immediately, without even the minimal delay imposed by submitting an RFQ. The advantage of an RFQ is that it allows buyers placing large orders to leverage this volume to negotiate better deals. The advantage of marketplace 150 is that it facilitates rapid transaction processing at established prices.

An embodiment of the present invention can allow buyers to search across multiple catalogs at once, thereby facilitating comparison shopping from among multiple suppliers. An interface facilitating such searching is preferably not available from within privately labeled catalogs, but rather from a buyer-oriented web site provided as part of the present invention. The interface may also allow buyers to purchase one or more materials from one or more sellers at the same time, and through a single payment transaction. On the back-end, the present invention can split up the purchase and, in a manner similar to the RFQ system, route the relevant material orders to each supplier for delivery.

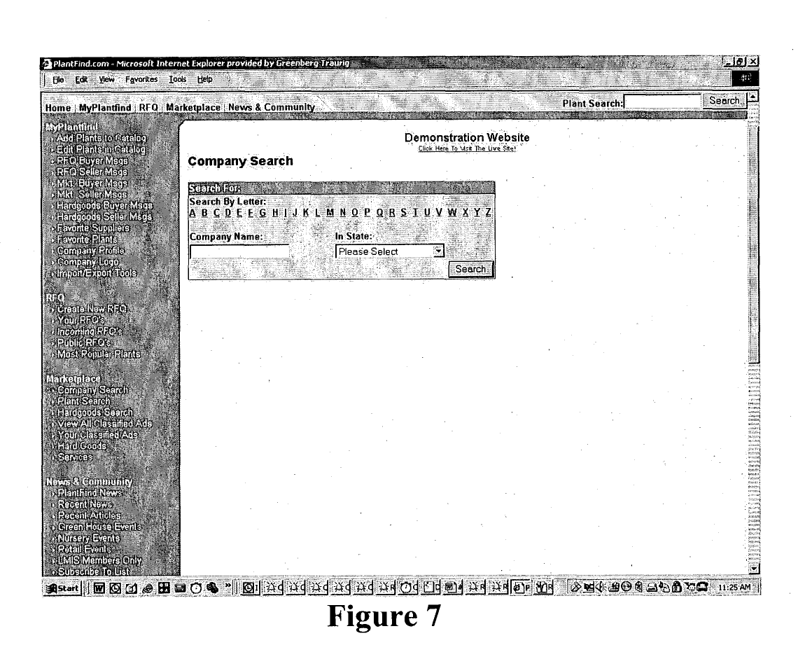

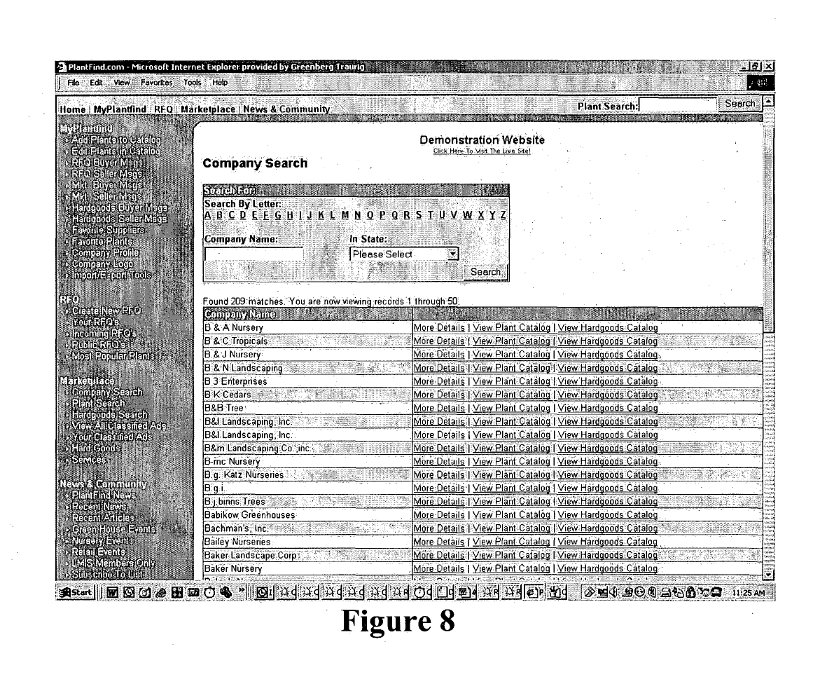

Buyers may also use marketplace 150 as a means of locating suppliers based on a variety of factors, such as name, geographic area, material specialty, or the like. FIG. 7 is a screen capture of a sample user interface which allows a user to search for suppliers by name and/or geographic location. FIG. 8 is a screen capture of a sample user interface providing a report of suppliers matching a user search request.

Virtual Trade Show 100

Because the Green Industry is so fragmented, a large number of regional trade shows have sprung up as showcases through which suppliers can publicize the materials they carry, and for buyers to expose themselves to new materials, information, technologies, or practices. Such trade shows are usually, but not always, sponsored by a state or industry association and vary in location, scope, size, attendance, target audience, and other factors.

There is typically a substantial overlap in most shows, with the only difference in some shows being the geographic region in which the show takes place. Because of the general layout of plant hardness “zones” across the United States and around the world, plants grown in one latitude will many times transplant nicely to another location within the same latitude. This can cause shows in different states but within the same hardness zone to be similar enough that it is neither practical nor cost effective for a buyer to attend both shows. Similarly, suppliers are not able to attend every show, even though their materials may be of interest to buyers attending a given show.

Furthermore, due to budgetary constraints on organizers and exhibitors, trade shows also are limited in duration, typically lasting only two to three days. It is frequently difficult to determine which exhibitors will have presentations at a given show until very close to the trade show date, at which time a buyer may already have committed to other obligations, even though a new materials of interest might be on exhibit. Furthermore, even once a buyer attending a typical trade show identifies one or more materials of interest, both the buyer and the seller have only limited access to information about each other, such as business cards and pamphlets picked up at the show.

Virtual trade show (100) allows trade show sponsoring groups to extend their reach by presenting exhibitor information online to potential buyers, including those who might not otherwise attend the trade show. Thus, the sponsoring groups can encourage more visitors to attend an actual trade show. Furthermore, exhibitors can obtain detailed information available to prospective buyers well after the trade show has ended. By extending the duration of a trade show, including displaying previews of exhibitor materials, exhibitor locations on the trade show floor, and providing the ability for the non-attending buyers to download product information and other literature both before and after the show, virtual trade show 100 can result in significant benefits to both exhibitors and sponsors. For exhibitors and attendees who would like to have a presence at a show to either buy or sell product but are unable to attend (e.g. they are involved in another show in another area of the country), a preferred virtual trade show 100 embodiment expands each virtual trade show by displaying exhibitors who will actually have a presence at a corresponding real trade show in a specific area of virtual trade show 100, while those exhibitors and attendees having only an electronic presence can be displayed in a separate area.

For exhibitors, virtual trade show 100 provides a means of promoting their company outside of the normal confines of a trade show by displaying banners and making promotional literature available. Virtual trade show 100 also reduces the overall cost of attending the show (literature distributed online is essentially free to publish), and allows “attendance” at shows that otherwise would be missed due to time conflicts or financial constraints. Virtual trade show 100 can also facilitate management of actual trade shows by allowing potential exhibitors to review and purchase booth space online, including reviewing one or more proposed locations relative to concessions, doorways, competitors, and other items of interest.

For attendees, virtual trade show 100 preferably integrates with one or more online travel services, thereby allowing an attendee to organize attendance by purchasing travel tickets and hotel rooms. Virtual trade show 100 also preferably allows attendees to purchase trade show tickets, preview exhibitors, obtain product information prior to the show, and even schedule extended meetings with exhibitors of interest.

Botanical Seed Auction 120

Botanical seed auction is a specialized online auction directed at the large number of botanical gardens in the United States that make excess seeds or other materials available to the Green Industry. The excess materials offered by these gardens typically represent a broader genetic pool, which allows growers to breed plants for greater disease resistance, among other desirable traits. The excess materials may also include unusual, rare, distinct, or hard to find materials that are not commonly available. According to a preferred embodiment of the present invention, botanical seed auction 120 allows each bidder to submit one and only one bid, while not publicly displaying any previously received bid placed by other bidders (referred to herein as a “single, sealed bid auction”). At the end of the auction, the bidder with the highest valued bid will receive the seed lot being auctioned off.

The present invention provides a system and methods facilitating commerce between at least one buyer and at least one seller in a commodity-based market, such as, but not limited to, the Green Industry, automotive parts, restaurant goods and equipment, and the like. While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A system for managing and transacting business in a component-based industry, comprising:
at least one database, for storing information about materials used in the industry, for storing information about at least one supplier, and for tracking the materials offered by the at least one supplier;
at least one server;
business management software running on the at least one server, wherein such business management software allows the at least one supplier to access and manage the information stored in the at least one database;
a quotation request entry interface, for use by a buyer;
a quotation request processor; and,
a marketplace interface, for facilitating commercial transactions.

2. The business management and transaction system of claim 1, wherein the quotation request processor receives quotations entered through the quotation request entry interface and correlates the quotation entries with information stored in the at least one database to generate at least one request for quotation.

3. The business management and transaction system of claim 2, wherein separate requests for quotation are generated for each of the at least one suppliers whose materials appear on the request for quotation.

4. The business management and transaction system of claim 3, wherein the requests for quotation generated for each of the at least one suppliers contain only the materials offered by the supplier for whom the quotation is generated.

5. The business management and transaction system of claim 1, wherein the marketplace allows the buyer to search materials stored in the at least one database.

6. The business management and transaction system of claim 1, wherein the marketplace allows the buyer to purchase materials from a plurality of the at least one suppliers in a single transaction.

7. The business management and transaction system of claim 1, wherein the marketplace allows the at least one supplier to create a privately labeled storefront from which at least one material can be purchased.

8. The business management and transaction system of claim 1, wherein the business management software manages inventory information for at least one of the suppliers.

9. The business management and transaction system of claim 8, wherein the business management software also tracks accounts payable and accounts receivable.

10. The business management and transaction system of claim 9, wherein the business management software also performs standard payroll accounting functions.

11. The business management and transaction system of claim 1, further comprising a virtual trade show interface.

12. The business management and transaction system of claim 1, further comprising a material auction interface.

13. The business management and transaction system of claim 12, wherein the material auction interface uses a single, sealed bid auction format.
